(19) United States
(12) Patent Application Publication
(10) Pub. No.: US 2003/0035081 A1
(43) Pub. Date: Feb. 20, 2003

(54) Liquid crystal display and light irradiating apparatus therefor

(75) Inventors: Sung-Wook Jung, Seoul (KR); Sang-Jun Lee, Suwon-city (KR); Woo-Shih Lee, Seoul (KR); Yong-Joon Kwon, Seoul (KR)

Correspondence Address: Frank Chau, F. CHAU & ASSOCIATES, LLP, Suite 501, 1900 Hempstead Turnpike, East Meadow, NY, 11554, US

(73) Assignee: Samsung Electronics Co., Ltd.

(21) Appl. No.: 10/150,444

(22) Filed: May 17, 2002

(30) Foreign Application Priority Data
Aug. 20, 2001 (KR) 2001-49966
Sep. 28, 2001 (KR) 2001-60445

(51) Int. Cl. G02F 1/1345

(52) U.S. Cl. 349/152

(57) ABSTRACT

A liquid crystal device includes panels disposed opposite each other along a major surface, a liquid crystal layer interposed between the panels, a sealant disposed between the panels for confining the liquid crystal layer, a display area defined within the liquid crystal layer, a fan out area adjacent to the display area, and signal lines overlapped by the sealant in the fan out area where the distance between adjacent signal lines is one to ten times as large as the width of the signal lines; and a corresponding method for curing a liquid crystal device includes supporting the liquid crystal device, emitting light for curing the sealant, and redirecting the emitted light towards at least one surface of the liquid crystal device.

### BACKGROUND OF THE INVENTION

(a) Field of the Invention

The present invention relates to a liquid crystal display and a light irradiating apparatus for hardening a sealant used in a liquid crystal display.

(b) Description of the Related Art

In general, a liquid crystal display (“LCD”) includes two panels and a liquid crystal layer with dielectric anisotropy disposed therebetween. The two panels are assembled with a sealant printed on the panels. A plurality of spacers are distributed between the panels to make a gap therebetween, the gap filled with the liquid crystal layer and confined by the sealant.

The LCD displays images by adjusting the intensity of electric fields, which are generated by electrodes provided on the panels and applied to the liquid crystal layer to control the amount of light transmitted through the panels.

For manufacturing such an LCD, a plurality of electrical wires for transmitting signals, a plurality of field-generating electrodes electrically connected to the wires, and an array of color filters for representing a variety of colors are formed on the panels. Thereafter, a pair of aligning films are coated on the surfaces of the panels and processed for aligning liquid crystal molecules. A plurality of spacers are distributed on one of the two panels, and a sealant having an inlet for injecting liquid crystal material is printed around the periphery of one panel. Subsequently, the panels are attached to each other using the sealant after they are aligned. Finally, liquid crystal material is injected into the gap between the panels through the inlet, which, in turn, is blocked to complete a liquid crystal panel assembly.

A thermosetting material or ultraviolet light curable material can be used as the sealant. When using the ultraviolet light curable material, the attachment of the panels is performed with irradiating ultraviolet light.

At least one of the panels has a black matrix for preventing light leakage at a circumference of a display area where images are displayed, or a plurality of signal lines for transmitting scanning signals or image signals. When such a panel is irradiated with ultraviolet light, the portions of the sealant overlapping the black matrix or the signal lines may not be sufficiently hardened where the ultraviolet light is blocked by the black matrix or the signal lines, thereby resulting in poor attachment of the two panels due to incomplete hardening or curing of the sealant. In addition, the uncured sealant may inadvertently mix with the liquid crystal material to contaminate the liquid crystal material, thereby causing the deterioration of display characteristic of the LCD.

### SUMMARY OF THE INVENTION

These and other drawbacks and disadvantages of the prior art are addressed by an apparatus and method for curing a liquid crystal device. A liquid crystal device includes panels disposed opposite each other along a major surface, a liquid crystal layer interposed between the panels, a sealant disposed between the panels for confining the liquid crystal layer, a display area defined within the liquid crystal layer, a fan out area adjacent to the display area, and signal lines overlapped by the sealant in the fan out area where the distance between adjacent signal lines is one to ten times as large as the width of the signal lines.

A corresponding method is disclosed for curing a liquid crystal device. The method includes supporting the liquid crystal device, emitting light for curing the sealant, and redirecting the emitted light towards at least one surface of the liquid crystal device.

According to the present invention, the width of a signal line and the distance between adjacent signal lines are properly adjusted, or the incident angle of the light on display panels is varied.

A liquid crystal display panel according to the present invention includes an insulating substrate, a plurality of signal lines provided on the substrate, and a plurality of signal pads connected with the signal lines and receiving signals from an external device. The distance between the signal lines near the signal pads is one to ten times as large as the width of the signal lines.

The width of the signal lines is preferably about 10 to about 100 microns. The signal lines are preferably bent near the signal pads.

A liquid crystal display according to an embodiment of the present invention includes a display area, a pad area, and a fan out area. The display area where images are displayed has a plurality of gate lines for transmitting scanning signals and a plurality of data lines for transmitting image signals. The pad area has a plurality of gate pads and a plurality of data pads. The gate pads are connected to the gate lines to transmit the scanning signals from an external source to the gate lines, and the data pads are connected to the data lines to transmit the image signals from an external source to the data lines. The fan out area is disposed between the display area and the pad area and has a sealant for confining liquid crystal material. The sealant surrounds the display area and overlaps at least one of the gate lines and the data lines but does not overlap the gate pads and the data pads.

Preferably, the distance between adjacent ones among the gate lines and the data lines in the fan out area is one to ten times as large as the width of the adjacent lines. The width of the adjacent lines preferably ranges from about 10 to about 100 microns.

The sealant is preferably ultraviolet light curable. According to an embodiment of the present invention, at least one of the gate lines and the data lines is bent in the fan out area, and at least a portion of the sealant overlaps the bent portion of the at least one of the gate lines and the data lines.

A light irradiating apparatus for a liquid crystal display according to the present invention includes a light-emitting member, a supporting member supporting a liquid crystal panel assembly including two opposite panels and a photo curable sealant formed between the two panels, and a light path-changing member for changing a traveling direction of light emitted from the light-emitting member. The light path-changing member is arranged so that it is disposed at least one of top, bottom and lateral sides of the liquid crystal panel assembly.

Preferably, the light from the light-emitting member comprises ultraviolet light. The light path-changing member preferably reflects or scatters light and preferably has an uneven surface for randomly reflecting light.

According to an embodiment of the present invention, the light path-changing member is disposed above the support member, which is preferably integrated with the supporting member, so that the liquid crystal panel assembly is placed on the light path-changing member.

A light irradiating apparatus according to an embodiment of the present invention further includes a light transmission member disposed above the light path-changing member so that the liquid crystal panel assembly is placed on the light transmission member.

According to an embodiment of the present invention, the light path-changing member includes a first changer disposed between the supporting member and the light-emitting member. The light path-changing member further includes a second changer disposed between the supporting member and the light-emitting member so that the liquid crystal panel assembly is placed between the first and the second changers.

According to an embodiment of the present invention, the light path-changing member further includes a plurality of changers arranged in multiple stages so that the changers are disposed at lateral sides of the liquid crystal panel assembly.

According to an embodiment of the present invention, the light path-changing member has an inclined reflecting surface, and is arranged so that the light path-changing member is located at a lateral side of the liquid crystal panel assembly.

These and other aspects, features and advantages of the present disclosure will become apparent from the following description of exemplary embodiments, which is to be read in connection with the accompanying drawings.

### BRIEF DESCRIPTION OF THE DRAWINGS

The above and other objects and advantages of the present invention will become more apparent by describing in detail exemplary preferred embodiments thereof with reference to the accompanying drawings in which:

FIG. 1 is a schematic layout view of an LCD according to a first embodiment of the present invention;

FIG. 2 is a cross-sectional view taken along II-II′ of FIG. 1;

FIG. 3 is a detailed layout view showing a part indicated by III of FIG. 1;

FIG. 4 shows a Raman spectrum of sealants;

FIGS. 5 to 7 are schematic diagrams showing light irradiating apparatus for an LCD according to second to fourth embodiments of the present invention, respectively;

FIG. 8 is a schematic view of a sample used to measure the hardness of sealants;

FIG. 9 is a graph showing the hardness of sealants as a function of measuring points; and

FIGS. 10 to 13 are schematic views showing light irradiating apparatus for an LCD according to fifth to eighth embodiments of the present invention, respectively.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present. Then, liquid crystal displays and light irradiating apparatus according to embodiments of the present invention will be described with reference to the drawings.

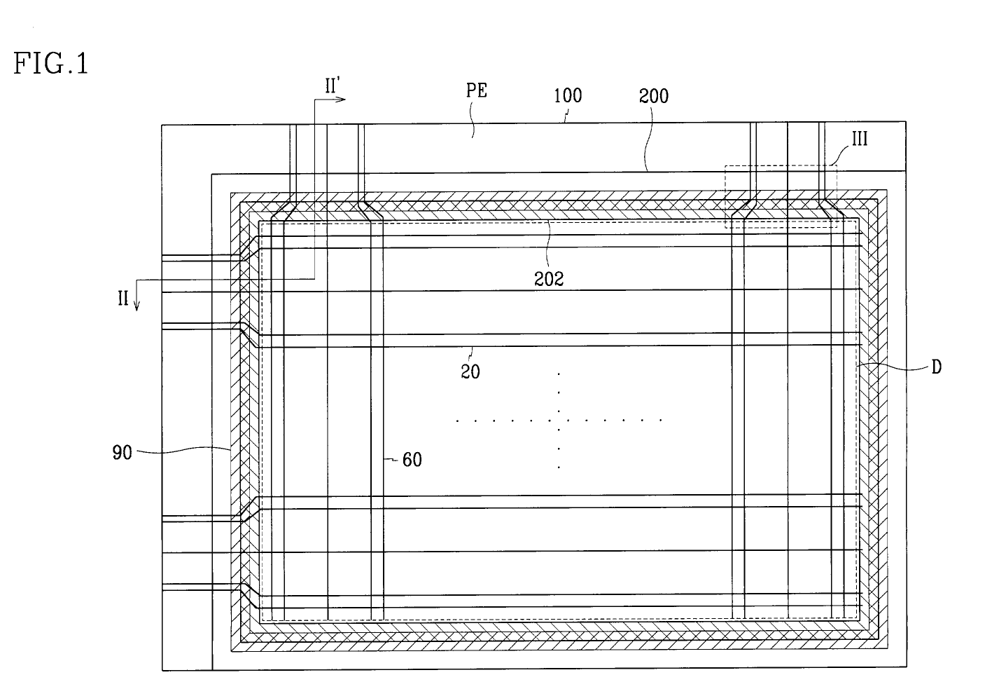

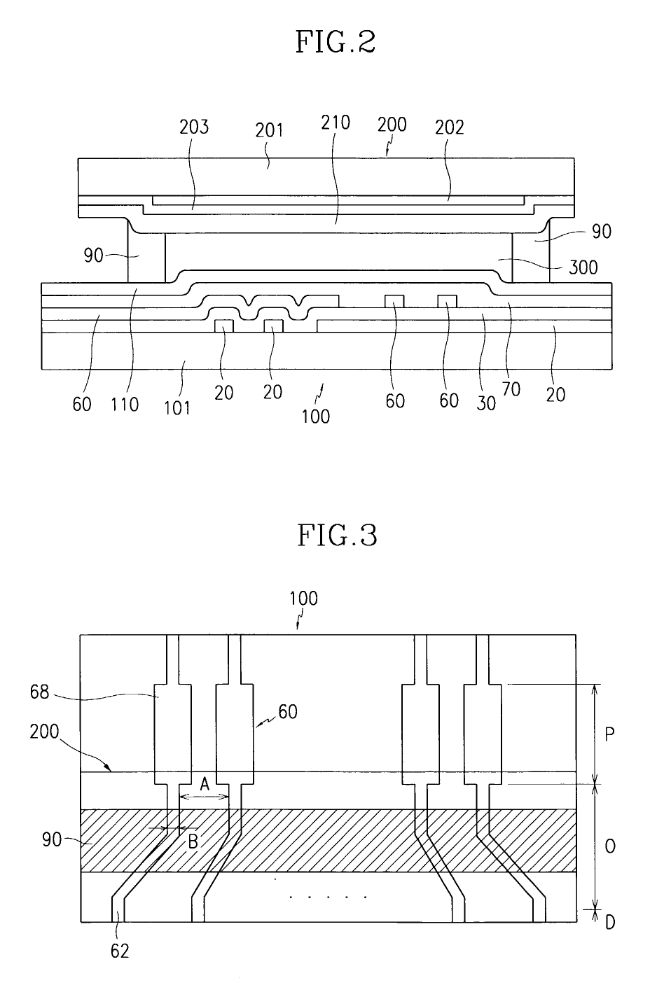

A structure of an LCD according to a first embodiment of the present invention will be described with reference to FIGS. 1 and 2.

FIG. 1 is a schematic layout view of an LCD according to a first embodiment of the present invention, and FIG. 2 is a cross-sectional view taken along II-II′ of FIG. 1.

As shown in FIGS. 1 and 2, an LCD according to the present invention includes two opposite panels, i.e., a lower panel 100 and an upper panel 200, a liquid crystal layer 300 disposed between the two panels 100 and 200, and a sealant 90 formed between the two panels 100 and 200 for confining the liquid crystal material layer 300.

The lower panel 100 is larger than the upper panel 200 and is divided into a display area D for displaying images and a peripheral area PE outside the display area D.

The sealant 90 is provided on the peripheral area PE and has a shape of a closed-rectangle formed along edges of the lower panel 100. Since the sealant 90 does not have an inlet for injecting liquid crystal material, the liquid crystal material is dropped and contained in a region enclosed by the sealant 90 before assembling the upper panel 200 and the lower panel 100, and then the upper panel 200 is placed on the sealant 90. Since it is difficult to adjust the amount of liquid crystal material, a protrusion (not shown) for reserving surplus liquid crystal material is preferably provided at the closed-rectangle-shaped sealant 90. A sufficient amount of the liquid crystal material is contained, and the excess of the liquid crystal material is gathered into a region defined by the protrusions. The sealant 90 is preferably made of light curable material, particularly the type hardened by ultraviolet light, and preferably, an anti-reflection film (not shown) for preventing a reaction between the sealant 90 and the liquid crystal material is formed on the sealant 90.

A plurality of spherical, ellipsoidal or the like spacers (not shown) for supporting the two panels 100 and 200 in parallel may be mixed with the liquid crystal layer 300 and the sealant 90. Alternately, a plurality of projections (not shown) made of silicon nitride or organic insulating material may be provided instead of spherical spacers.

Referring to FIGS. 1 and 2 again, the lower panel 100 of the LCD according to the first embodiment of the present invention includes an insulating substrate 101, a gate wire 20 and a data wire 60, which are provided on the substrate 101. The gate wire 20 and the data wire 60 are made of conductive material with low resistivity and are insulated from each other via a gate insulating film (not shown) interposed therebetween. The gate wire 20 includes a plurality of gate lines extending in a transverse direction, a plurality of gate electrodes of thin film transistors connected thereto and a plurality of gate pads connected to end portions of the gate lines. The gate lines and the gate electrodes are located substantially in the display area D, while the gate pads are in the peripheral area. Scanning signals from an external source are transmitted to the gate electrodes via the gate pads and the gate lines.

Referring to FIG. 3, the data wire 60 includes a plurality of data lines 62, a plurality of source electrodes (not shown) and drain electrodes (not shown) of the thin film transistors, and a plurality of the data pads 68. The data lines 62 extend in a longitudinal direction in the display area D and intersect the gate lines. The source electrodes are connected to the data lines 62, and the drain electrodes are located opposite the source electrodes with respect to channels of the thin film transistors. The data pads 68 are located in the peripheral area PE and connected to end portions of the data lines 62. The data pads 68 deliver image signals to the data lines 62 after receiving the image signals from an external source, which, in turn, is supplied to the source electrodes. Upon application of the scanning signal at the gate electrodes, the thin film transistors are turned on to output the image signals through the drain electrodes of the thin film transistors.

Referring back to FIG. 2, the data wire 60 is covered with a passivation film or a protection film 70 having a contact hole exposing the drain electrode. A plurality of pixel electrodes (not shown) are formed on the protection film 70, and connected to the drain electrode through the contact hole. The pixel electrodes are preferably located substantially in pixel areas arranged in a matrix, each pixel area being defined by an area surrounded by two adjacent gate lines and two adjacent data lines. The pixel electrodes are preferably made of transparent conductive material such as ITO (indium tin oxide) or IZO (indium zinc oxide), or opaque conductive material having high reflectivity.

A plurality of storage electrodes (not shown) may be provided on the lower substrate 101. The storage electrodes are supplied with a voltage such as a common electrode voltage, and overlap the pixel electrodes via an insulator to form storage capacitors for improving the charge storage and conservation capabilities of the pixels. The storage electrodes are preferably separated from the gate lines.

As shown in FIG. 2, the upper panel 200 opposite the lower panel 100 includes an insulating substrate 201 and a black matrix 202, a common electrode 203, and a plurality of color filters (not shown) provided on the substrate 201. The black matrix 202 has openings arranged in a matrix opposite pixel areas of the lower panel 100. The black matrix 202 is also formed at a circumference of the display area D for blocking light leakage at the circumference. The color filters include red, green and blue color filters, and are disposed at the openings of the black matrix 202. The red, green and blue color filters are arranged preferably in three shifts in a column direction and in a row direction. However, they are arranged so that either a row or a column is provided with the filters with a single color. The color filters and so on are preferably covered with a protection film having an excellent planarization property.

A pair of aligning films 110 and 210 is provided on the respective substrates 101 and 201. The aligning films 110 and 210 are rubbed so that the liquid crystal molecules of the liquid crystal layer 300 are oriented in predetermined directions.

As shown in FIG. 1, since the lower panel 100 is larger than the upper panel 200, the wires 20 and 60 are projected outside of the upper panel 200.

FIG. 3 is a detailed layout view showing a part indicated by III in FIG. 1, near the data pads 68. As shown in FIG. 3, the peripheral area PE is divided into a pad area P and a fan out area O located between the display area D and the pad area P. The gate pads and the data pads 68 are located in the pad area P, and the sealant 90 is located in the fan out area O. The portions of the data lines 62 in the fan out area O are bent for connection to the data pads 68. It is apparent that the data lines 62 in the fan out area O may extend in a straight manner without bending, causing the distance between the data pads 68 to be large.

When ultraviolet light is irradiated into the bottom surface of the lower panel 100 in order to harden the sealant 90, initiators included in the sealant 90 cause the monomers or polymers included in the sealant 90 to react. Since this reaction progresses sequentially from a portion directly exposed to ultraviolet light to other portions, some portions of the sealant 90 on the data lines 62, although not directly exposed to the light, can be hardened. Accordingly, by properly adjusting the area occupied by the data lines 62 and the distance between the data lines 62, all portions of the sealant 90 can be hardened. According to this embodiment, the distance (A) between the neighboring data lines 62 in the fan out area O is about one to about ten times as large as the width B of the data lines 62, and the width B is preferably about 10 to about 100 microns. Since the layout near the gate lines is similar to that near the data lines, the same rules are preferably applied to the width of the gate lines and the distance therebetween in the fan out area O.

The experimental hardness of sealants formed on signal lines in the fan out area was measured for three cases. The first case (X) was that ultraviolet light was not irradiated on the sealant. The second case (Y) was that the distance (A) of 20.29 microns between the signal lines was smaller than the width (B) of 29.16 microns of the signal lines, and the third case (Z) was that the distance (A) of 122.47 microns between the signal lines was 6.8 times larger than the width (B) of 18 microns of the signal lines. Here, D70E1 available from Kyoritsu Company was used as the sealant and the hardness of the sealant was measured using a Raman spectrum.

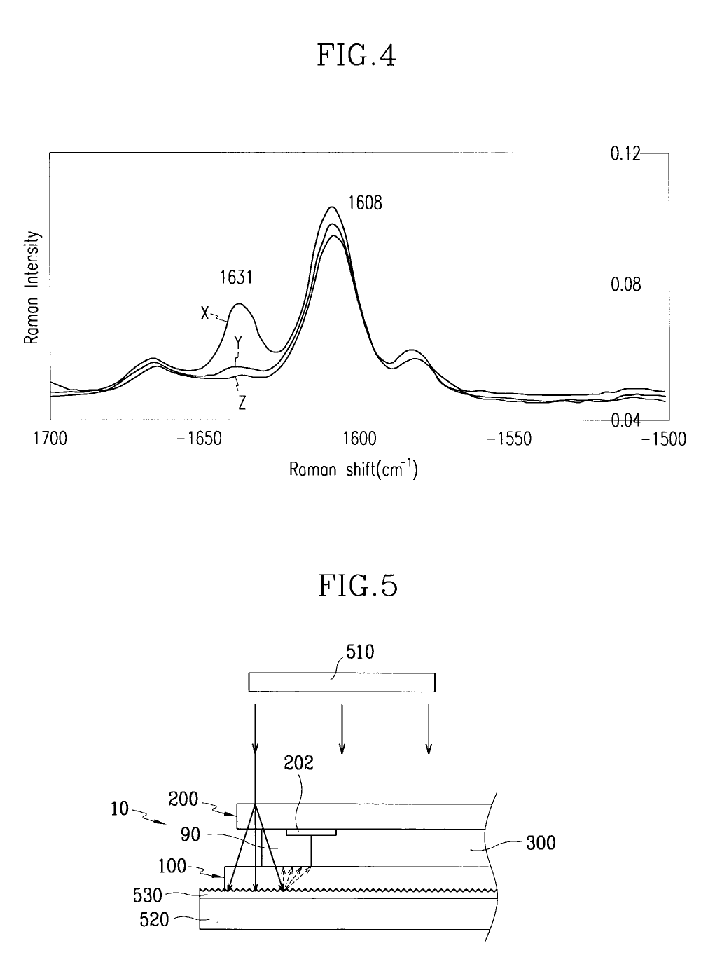

FIG. 4 shows the Raman spectrum of the sealants, in which the horizontal axis indicates Raman shift (cm⁻¹) and the vertical axis indicates Raman intensity. 1608 cm⁻¹ peaks shown in FIG. 4 represent benzene ring structures, which do not participate in a hardening reaction, while 1631 cm⁻¹ peaks represent carbon double bonds, which participate in the hardening reaction. In FIG. 4, the curve for the case (Z) has the lowest 1631 cm⁻¹ peak, which states that the hardness of the sealant for the case (Z) was the highest among the three cases.

The procedure for obtaining the hardness from the Raman spectrum will be described. The 0% hardness is defined as the hardness of a case where no portions of the sealant are hardened. For example, the hardness of the case (X) is 0% since ultraviolet light is not irradiated. The 100% hardness is defined as the hardness of a case that the sealant is completely hardened. Raman spectrum curves are obtained for the 0% hardness and the 100% hardness. Each curve has a 1608 cm⁻¹ peak and a 1631 cm⁻¹ peak. Both valleys adjacent to the 1608 cm⁻¹ peak are connected by a straight line to define an area surrounded by the spectrum curve and the straight line. An area for the 1631 cm⁻¹ peak is also defined in the same manner. The ratio of the 1631 area to the 1608 area is calculated. If the area ratio of the 0% hardness is r₁ and the area ratio of the 100% hardness is r₂, the hardness H for the area ratio r is given by the following expression:

$$H = 100 \times \frac{{r}_{1} - r}{{r}_{1} - {r}_{2}} . \qquad ( 1 )$$

From the above expression, it can be seen that the larger the area ratio r becomes, the smaller the hardness H. Since the area ratio r is given as (1631 area)/(1608 area) and the values of the 1608 areas of the three cases are similar as shown in FIG. 4, the hardness is substantially determined by the 1631 area. From FIG. 4, it can be seen that the hardness for the case (Z) is higher than that for the case (Y) since the former has the 1631 area smaller than that of the latter.

In this experiment, r₁=0.5 and r₂=0.1, and thus H=100·[(0.5−r)/0.4]. For the curves of FIG. 4, the case (X) with r=0.5 shows 0% hardness as described above, the case (Y) with r=0.14 shows 90% hardness, and the case (Z) with r=about 0.1 shows nearly 100% hardness.

According to another embodiment of the present invention, for the purpose of complete hardening of the sealant, light can be uniformly irradiated on sealants by modifying a method and an apparatus for irradiating light, instead of changing the structure of an LCD itself. For example, when the light is irradiated from the top of the LCD, a reflector or a scattering plate is provided between the light source and the LCD and/or at the bottom and/or the lateral sides of the LCD. Such a method or an apparatus will be described in detail.

FIG. 5 is a schematic diagram showing a light irradiating apparatus for an LCD according to a second embodiment of the present invention. FIG. 5 shows only parts of an LCD 1, i.e., lower and upper panels 100 and 200, a liquid crystal layer 300, a sealant 90 and a black matrix 202, for representing reflection or scattering of light.

As shown in FIG. 5, a light irradiating apparatus according to the second embodiment of the present invention includes a light-emitting lamp 510 for generating light such as ultraviolet light, a supporting member 520 located under the lamp 510, and a reflection plate 530 provided on the supporting member 520. The LCD 10 to be exposed to the light is placed on the reflection plate 530. The reflection plate 530 may be integrated with the supporting member 520.

It is preferable that the reflection plate 530 is made of metallic material with good reflectivity, and has an uneven surface processed by such methods as grinding so that light can be reflected in various or random directions.

The reflection plate 530 of the light irradiating apparatus reflects the light after it is emitted from the lamp 510 and passed through the LCD 10 back into the panel assembly in various directions. Accordingly, the light can also arrive at portions of the sealant 90 located under the signal lines (20 and 60 in FIG. 1) or under the black matrix 202, allowing the hardness of the sealant 90 to be maximized.

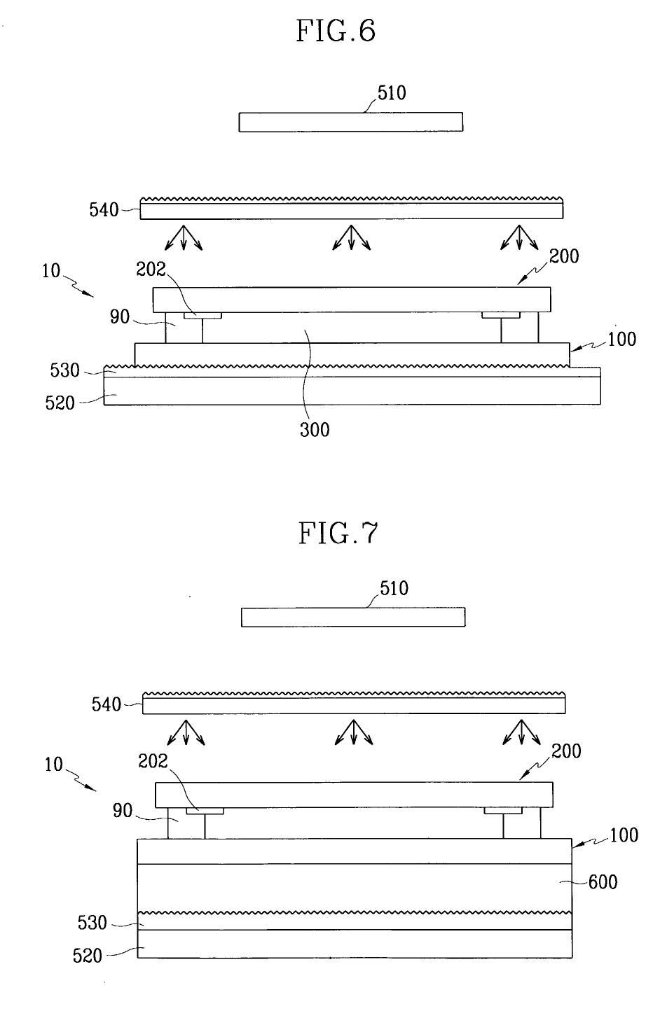

FIGS. 6 and 7 are schematic diagrams showing light irradiating apparatus for an LCD according to third and fourth embodiments of the present invention, respectively.

As shown in FIG. 6, a light irradiating apparatus according to the third embodiment of the present invention includes a scattering plate 540 for scattering light in addition to a reflection plate 530, which is also provided in the light irradiating apparatus of the second embodiment. The scattering plate 540 is located between a light emitting lamp 510 and the reflection plate 530, and scatters the light emitted from the lamp 510 to direct it to the liquid crystal display 1.

The light from the lamp 510 in this embodiment is obliquely incident on the LCD 10 in various directions, while the light from the lamp 510 in the second embodiment is uniformly incident perpendicular to the LCD 1. In addition, the light arrives at the reflection plate 530 in various directions and is reflected by the reflection plate 530 to enter the sealant 90 in various directions. Therefore, more of the light can arrive at wider regions of the sealant 90, compared with the second embodiment.

As shown in FIG. 7, a light irradiating apparatus according to the fourth embodiment of the present invention has a spacer 600 with a predetermined thickness disposed over a reflection plate 530, which is provided in the third embodiment. The spacer 600 may be transparent or translucent and may also have a scattering property.

The spacer 600 increases the distance between an LCD 10 and the reflection plate 530, allowing the light reflected by the reflection plate 530 to enter the LCD 10 more widely and densely.

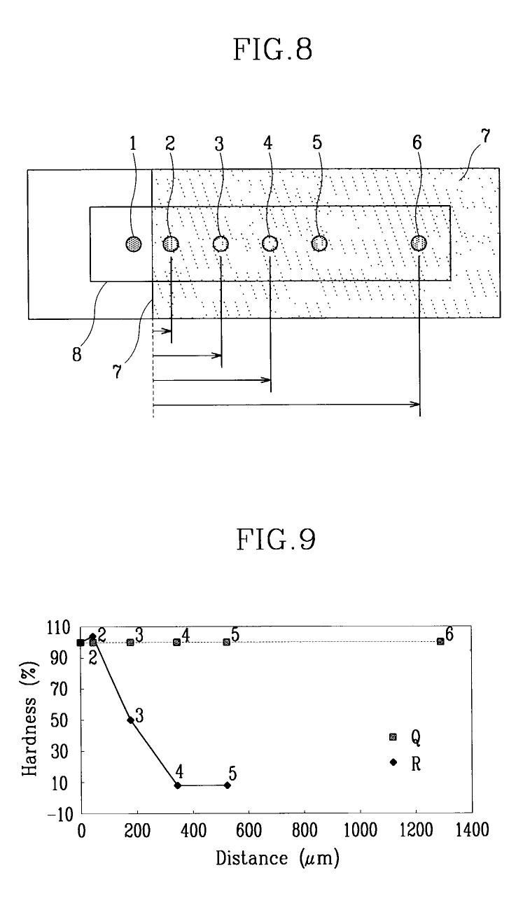

FIG. 8 is a schematic diagram of a sample used to measure the experimental hardness of sealants using a conventional ultraviolet light irradiating apparatus for an LCD, and using one according to an embodiment of the present invention. FIG. 9 is a graph showing the hardness of the sealants as a function of measuring points.

In this experiment, two pairs of 0.7 mm thick glass substrates were prepared. A shading portion 8 was formed by plating one substrate of each pair of the substrates with chrome (“Cr”). After ultraviolet light curable sealants 7 were applied on the substrates having the shading portions 8 such that the sealants 7 overlap the shading portions 8, the two substrates of each pair were bonded to each other. During the bonding, ultraviolet light is irradiated onto each substrate assembly, one assembly irradiated using a conventional ultraviolet light irradiating apparatus without a reflection plate and the other assembly irradiated using an ultraviolet light irradiating apparatus according to the second embodiment of the present invention. Here, D70E1 available from Kyoritsu Company was used as the sealant 7. The hardness of the sealant 7 was measured at six points 1 to 6 shown in FIG. 8. As shown in FIG. 8, point 1 is not covered by the shading portion 8 and points 2 to 6 are located at positions spaced apart by 50, 180, 330, 530 and 1,300 microns from a boundary of the shading portion 8, respectively.

The hardness of the sealants 7 shown in FIG. 9 was obtained by the same method as in FIGS. 4 through 7. In FIG. 9, Q indicates the hardness of the sealant 7 when using the reflection plate and R indicates the hardness of the sealant 7 without using a reflection plate.

As shown in FIG. 9, the hardness R of the sealant 7 for a conventional case without a reflection plate shows more than 90% at point 1 and point 2, which is spaced apart by 50 microns from the boundary of the shading portion 8, but it ranges from 0% to 50% at the remaining points. On the other hand, the hardness Q of the sealant 7 for the embodiment of the present invention with the reflection plate exhibits more than 90% at all points. As a result, it can be seen that the sealant 7 is fully hardened since the ultraviolet light reaches up to a center of the shading portion 8 when using the reflection plate.

Although the hardness of a sealant is increased by placing a reflection plate and/or a scattering plate at the top and/or the bottom of an LCD in the second to the fourth embodiments of the present invention, it also can be increased by placing them at the lateral sides of the LCD, which will be described in detail.

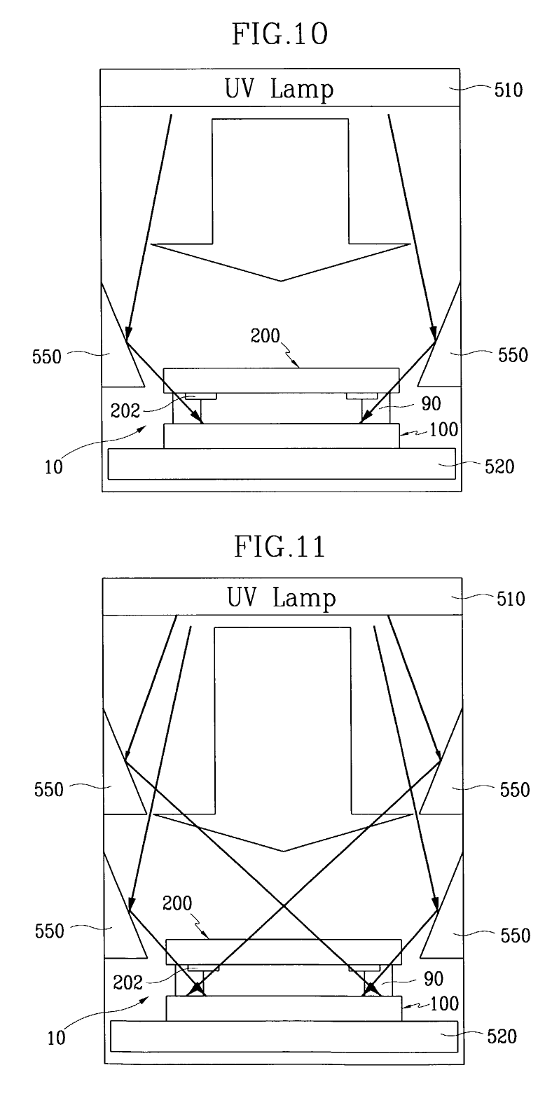

FIGS. 10 to 13 are schematic diagrams showing light irradiating apparatus of an LCD according to fifth to eighth embodiments of the present invention, respectively. As shown in FIG. 10, a light irradiating apparatus according to the fifth embodiment of the present invention includes a light emitting lamp 510 for generating light such as ultraviolet light, a supporting member 520 located under the lamp 520, and a pair of reflectors 550 located on both lateral sides above the supporting member 520. An LCD 10 is placed on the supporting member 520.

Each reflector 550 at the lateral side has an inclined reflecting surface for reflecting the light emitted from the lamp 510 to forward obliquely to the LCD 10 and to arrive at a light curable sealant 90 underlying a black matrix 202.

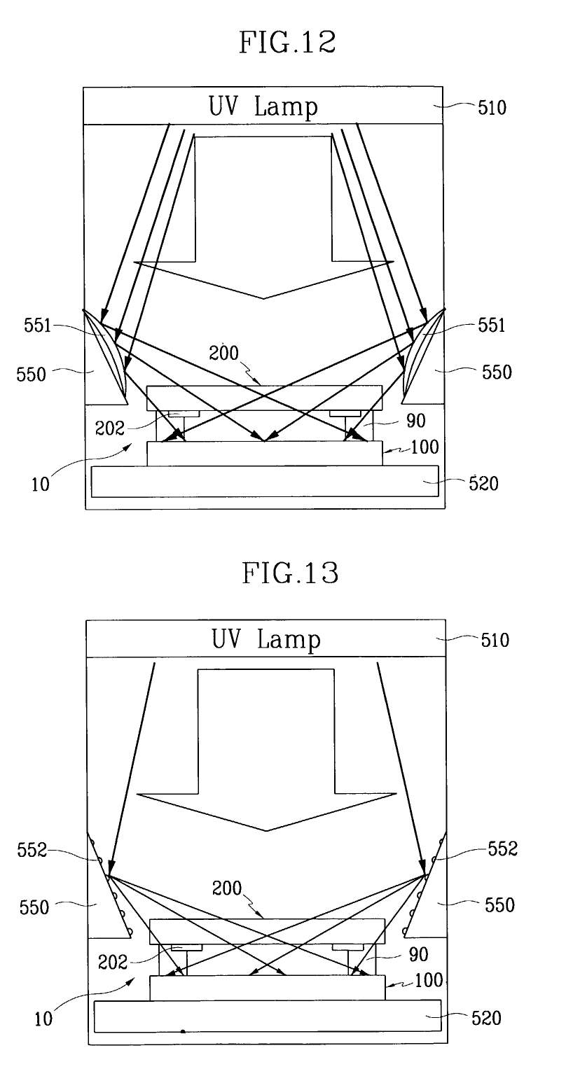

The number, the position, the shape and so on of reflectors can be diversely modified to maximize the hardness of a sealant. A plurality of reflectors 550 according to the sixth embodiment of the present invention are arranged up and down in multiple stages as shown in FIG. 11. A pair of reflectors 550 according to the seventh embodiment of the present invention has convex (or concave) focusing surfaces as shown in FIG. 12. A pair of reflectors 550 according to the eighth embodiment of the present invention have uneven surfaces 552 processed by embossing or grinding for randomly reflecting light as shown in FIG. 13.

The reflection plates and the scattering plates 530, 540 and 550 of the above-described second to eighth embodiments can be used separately or in combination.

Although preferred exemplary embodiments of the present invention have been described, it shall be understood that many variations and/or modifications of the basic inventive concepts may become apparent to those of ordinary skill in the pertinent art based on the teachings herein. Such variations and/or modifications will fall within the spirit and scope of the present invention, as defined in the appended claims.

What is claimed is:

1. A liquid crystal display panel comprising:
an insulating substrate;
a plurality of signal lines provided on the substrate; and
a plurality of signal pads connected to the signal lines for receiving signals from an external device,
wherein the distance between the signal lines near the signal pads is one to ten times as large as the width of the signal lines.

2. The liquid crystal display panel of claim 1, wherein the width of the signal lines is about 10 to about 100 microns.

3. The liquid crystal display panel of claim 2, wherein the signal lines are bent near the signal pads.

4. A liquid crystal display comprising:
a display area where images are displayed, the display area having a plurality of gate lines for transmitting scanning signals and a plurality of data lines for transmitting image signals;
a pad area having a plurality of gate pads and a plurality of data pads, the gate pads connected to the gate lines for transmitting the scanning signals from an external source to the gate lines and the data pads connected to the data lines for transmitting the image signals from an external source to the data lines; and
a fan out area disposed between the display area and the pad area and having a sealant for confining liquid crystal material, the sealant surrounding the display area and overlapping at least one of the gate lines and the data lines but not overlapping the gate pads and the data pads.

5. The liquid crystal display of claim 4, wherein the distance between adjacent ones among the gate lines and the data lines in the fan out area is one to ten times as large as the width of the adjacent lines.

6. The liquid crystal display of claim 5, wherein the width of the adjacent lines ranges from about 10 to about 100 microns.

7. The liquid crystal display of claim 4, wherein the sealant is ultraviolet light curable.

8. The liquid crystal display of claim 4, wherein at least one of the gate lines and the data lines are bent in the fan out area, and at least a portion of the sealant overlaps the bent portion of the at least one of the gate lines and the data lines.

9. A light irradiating apparatus for a liquid crystal display, comprising:
a light-emitting member;
a supporting member disposed relative to the light-emitting member for supporting a liquid crystal display including two opposite panels and a photo curable sealant formed between the two panels; and
a light path-changing member disposed relative to the light-emitting member for changing the travel direction of light emitted from the light-emitting member, the light path-changing member arranged so that the light path-changing member is disposed relative to at least one of a top, a bottom and a lateral side of the liquid crystal display.

10. The light irradiating apparatus of claim 9, wherein the light from the light-emitting member comprises ultraviolet light.

11. The light irradiating apparatus of claim 9, wherein the light path-changing member reflects or scatters light.

12. The light irradiating apparatus of claim 11, wherein the light path-changing member is disposed above the supporting member so that the liquid crystal display is placed on the light path-changing member.

13. The light irradiating apparatus of claim 12, wherein the light-path-changing member is integrated with the supporting member.

14. The light irradiating apparatus of claim 12, further comprising a light transmission member disposed above the light path-changing member so that the liquid crystal display is placed on the light transmission member.

15. The light irradiating apparatus of claim 11, wherein the light path-changing member has an uneven surface randomly reflecting light.

16. The light irradiating apparatus of claim 9, wherein the light path-changing member comprises a first changer disposed between the supporting member and the light-emitting member.

17. The light irradiating apparatus of claim 16, wherein the light path-changing member further comprises a second changer disposed between the supporting member and the light-emitting member so that the liquid crystal display is placed between the first and the second changers.

18. The light irradiating apparatus of claim 9, wherein the light path-changing member comprises a plurality of changers arranged in multiple stages so that the changers are disposed at lateral sides of the liquid crystal display.

19. The light irradiating apparatus of claim 9, wherein the light-path-changing member has an inclined reflecting surface and is arranged so that the light path-changing member is located at a lateral side of the liquid crystal display.

20. The light irradiating apparatus of claim 9 wherein the light path-changing member focuses light.

21. A method for curing a liquid crystal device having at least two opposite panels and a photo-curable sealant therebetween, the method comprising:
supporting the liquid crystal device;
emitting light for curing the photo-curable sealant; and
redirecting the emitted light towards at least one surface of the liquid crystal device.

22. A method as defined in claim 21 wherein the redirected light comprises ultraviolet light.

23. A method as defined in claim 21 wherein redirecting comprises at least one of reflecting and scattering the emitted light.

24. A method as defined in claim 21, further comprising transmitting the redirected light through a transmission member disposed relative to a surface of the liquid crystal device.

25. A method as defined in claim 21 wherein redirecting comprises randomly reflecting the emitted light from an uneven surface.

26. A method as defined in claim 21, further comprising reflecting light that has passed through the liquid crystal device back towards the liquid crystal device.

27. A method as defined in claim 26 wherein the reflected light is directed towards a part of the liquid crystal device different than it came through.

28. A method as defined in claim 21 wherein redirecting comprises changing the path of the emitted light at lateral sides of the liquid crystal device.

29. A method as defined in claim 21, further comprising inclining a reflecting surface so that the redirected light is directed towards a lateral side of the liquid crystal device.

30. A method as defined in claim 21, further comprising focusing the emitted light.

31. A method as defined in claim 21 wherein substantially all of the photo-curable sealant is cured.

32. A liquid crystal device comprising:
a plurality of panels disposed opposite each other along a major surface;
a liquid crystal layer interposed between at least one pair of the plurality of panels;
a sealant disposed between the at least one pair of the plurality of panels for confining the liquid crystal layer;
a display area defined within the liquid crystal layer;
a fan out area adjacent to the display area;
a plurality of signal lines overlapping the sealant in the fan out area wherein the distance between an adjacent pair of signal lines is one to ten times as large as the widths of the adjacent signal lines.

33. A liquid crystal device as defined in claim 32 wherein the signal lines comprise data lines and gate lines.

34. A liquid crystal device as defined in claim 32 wherein the widths of the plurality of signal lines range from about 10 microns to about 100 microns.

35. A liquid crystal device as defined in claim 32 wherein the widths of the adjacent signal lines range from about 10 microns to about 100 microns.

36. A liquid crystal device as defined in claim 32 wherein the sealant comprises an ultraviolet light curable material.

37. A liquid crystal device as defined in claim 32 wherein at least one of the plurality of signal lines is overlapped by the sealant.

38. A liquid crystal device as defined in claim 32 wherein at least one of the adjacent signal lines is overlapped by the sealant.

39. A liquid crystal device as defined in claim 32, further comprising a plurality of signal pads coupled to the signal lines in the fan out area.

40. A liquid crystal device as defined in claim 39 wherein the plurality of signal pads is not overlapped by the sealant.

41. A liquid crystal device as defined in claim 32 wherein the number of the plurality of panels is two.

42. A liquid crystal device as defined in claim 32 wherein the widths of the adjacent signal lines are equal.
